(19) United States
(12) Patent Application Publication
(10) Pub. No.: US 2006/0198120 A1
(43) Pub. Date: Sep. 7, 2006

(54) Lighted wrist band

(75) Inventor: Rudy Guzman, Coral Springs, FL (US)

Correspondence Address: GRAY ROBINSON, P.A., 401 E. LAS OLAS BLVD., SUITE 1850, FT. LAUDERDALE, FL, 33301, US

(73) Assignee: BBC International, Ltd.

(21) Appl. No.: 11/070,959

(22) Filed: Mar. 3, 2005

(51) Int. Cl. F21V 21/08

(52) U.S. Cl. 362/103

(57) ABSTRACT

This invention is directed to a wrist band having a decorative array of light sources such as LEDs illuminated by an integrated circuit which is activated by movement of an inertia switch to a closed position when a separate, manually-operated switch is closed.

### FIELD OF THE INVENTION

This invention relates to wrist bands, and, more particularly, to a wrist band having an array of light sources such as LEDs which are activated by movement of an inertia switch to the closed position after depressing a manually-activated switch.

### BACKGROUND OF THE INVENTION

For a number of years, articles of footwear and various items of clothing have been sold with decorative arrays of light sources such as light emitting diodes (LEDs). This has been particularly popular in children's shoes where the LEDs are arranged to complement other design elements of the shoe such as cartoon characters and the like.

In a typical design of this type, a module carried by the article of clothing is provided having a battery, a switch and, conventionally, an integrated circuit which is connected by wires to LEDs positioned at selected locations in or on the article of clothing. Systems of this type are shown, for example, in U.S. Pat. Nos. 6,525,487; 6,286,975; 6,012,822; 5,969,479; 5,894,201; 5,812,063 and others.

The integrated circuits employed in modules for these applications are commonly activated by one or more switches carried on or otherwise coupled to the module. In some designs, the switch turns on and off in response to the application of an inertial force, pressure or motion. Spring switches such as disclosed in U.S. Pat. Nos. RE37,220 and 5,909,088 are a popular choice because they are reliable, noiseless and movable from a neutral or off position to a closed or on position in response to motion of the article to which the module is attached.

Another type of switch employed in children's shoes and similar applications is a manually activated switch such as shown in U.S. Pat. Nos. 5,894,686; 6,278,378 and 5,813,148. Manual switches are used to turn on and off the light source carried by the article of clothing, to select different modes of operation for the integrated circuit associated with the clothing item, e.g. different flashing sequences or other operations, and for other purposes. One system, particularly intended for shoes and shown in the U.S. Pat. No. 5,813,148 patent, employs both manual and inertial switches to activate light sources and/or sound sources associated with the shoe. In the '148 system, the manual switch turns on and off a light source, and also causes a controller including an integrated circuit to activate a particular mode of operation. One of the modes of operation enables an inertia or pressure sensitive switch, which then operates to activate the light source in a selected flashing sequence.

### SUMMARY OF THE INVENTION

This invention is directed to a wrist band having a decorative array of light sources such as LEDs illuminated by an integrated circuit (“IC”) which is activated by movement of an inertia switch to a closed position when a separate, manually-operated switch is closed.

The wrist band has a body which mounts cooperating fastening elements at either end such as snaps, hook and loop fasteners and the like which allow the body to be secured on the wrist of a wearer. A decorative array of LEDs is mounted to the body, which is preferably also provided with designs such as a cartoon character. The IC, coupled to the LEDs, is activated in response to movement of the inertia switch to a closed position. The inertia switch, in turn, is enabled by depressing a manually-activated switch.

In response to closing of the manually-activated switch, the inertia switch is coupled to a battery carried by the body. When the wearer of the wrist band moves his or her arm, the inertia switch closes thus coupling the battery to the IC. In turn, the IC illuminates the LEDs in a flashing sequence which is repeated every time the inertia switch is close while the manually-activated switch remains in the closed position. In order to disconnect the battery from the IC, the manually-activated switch is opened.

### DESCRIPTION OF THE DRAWINGS

The structure, operation and advantages of the presently preferred embodiment of this invention will become further apparent upon consideration-of the following description, taken in conjunction with the accompanying drawings, wherein:

FIG. 1 is a plan view of the wrist band of this invention;;

FIG. 2 is a cross sectional view taken generally along line 2-2 of FIG. 1;

FIG. 3 is an enlarged view of the encircled portion of FIG. 2; and

FIG. 4 is schematic, block diagram of the electrical circuit employed in the wrist band herein.

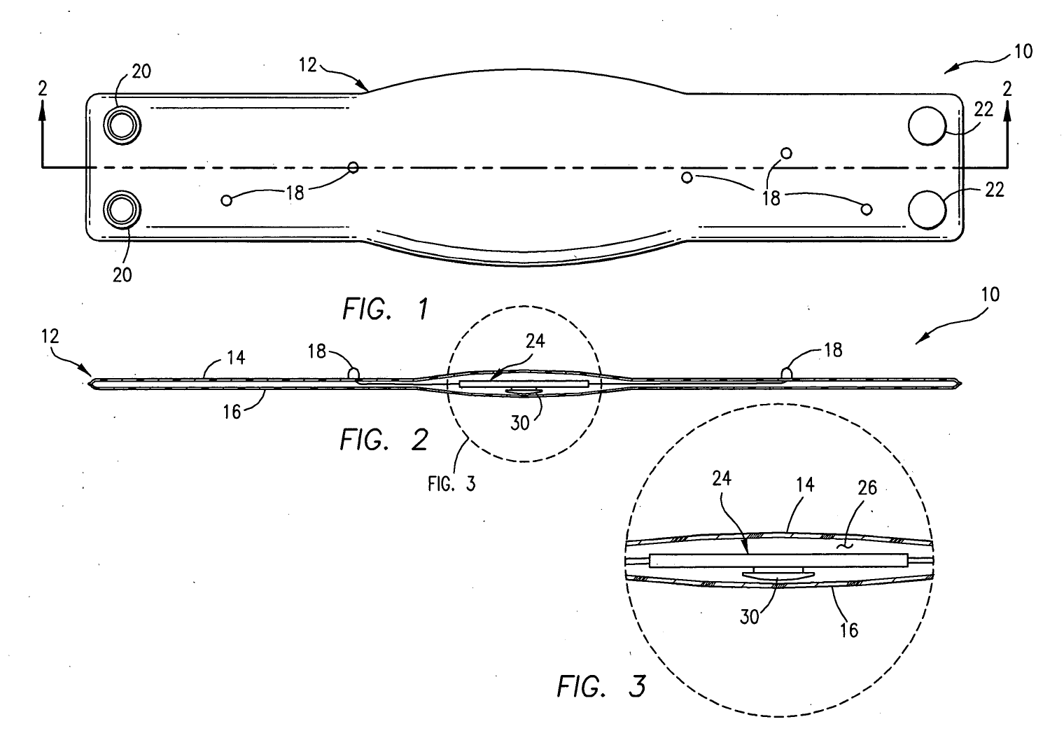

### DETAILED DESCRIPTION OF THE INVENTION

Referring now to the Figs., the wrist band 10 of this invention comprises a body 12 formed of two half sections 14 and 16 which are connected together at their peripheral edges by glue, stitching or some other permanent means of attachment. At least one of the half sections 14, 16 is decorated with a cartoon character, “super hero” or some other indicia popular with children (not shown). An array of light sources such as LEDs 18 is mounted to one or both of the half sections 14, 16 of the body 12.

One end of the body 12 mounts one or more fastening elements 20 and the opposite end mounts a fastening element 22 which readily engage and disengage with one another. A snap arrangement is shown in the Figs., but the fastening elements 20 and 22 may be cooperating hook and loop fasteners, a belt buckle type of fastener or any other suitable means of securing the body 12 to the wrist of a wearer.

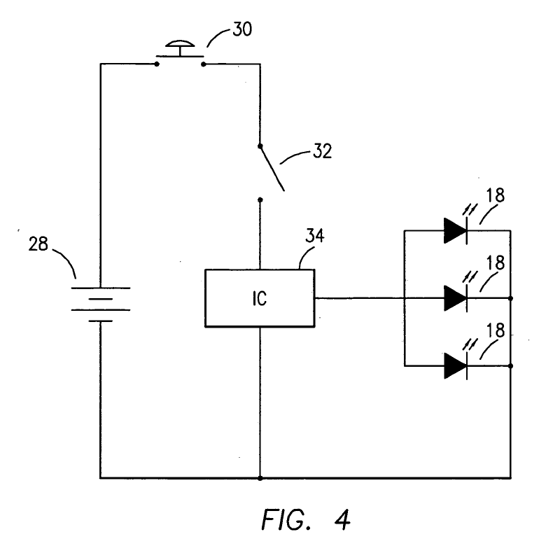

In the presently preferred embodiment, a module 24 is mounted in a space 26 between the half sections 14 and 16 of the body 12. The module 24 carries a battery 28, a manually-activated switch 30, an inertia switch 32 and an IC 34. These elements may be coupled together in series as depicted in FIG. 4. The IC 34, in turn, is coupled to the LEDs 18 by wires as schematically depicted in FIG. 4. While the elements 28, 30, 32 and 34 are illustrated as being carried on a module 24, it should be understood that they could be mounted in any suitable fashion within the space 26 between the half sections 14, 16 of the body 12.

One type of inertia switch 32 suitable for use in the module 24 is disclosed in U.S. Pat. No. 5,408,764. The IC 34 is available under part number 6608 from Cheerine Development (Hong Kong) Ltd., having a place of business at Room 1217, North Tower, Concordia Plaza, No. 1 Science Museum Road, Tsim Sha Tsui East, Kowloon, Hong Kong.

Preferably, but not necessarily, the manually-activated switch 30 is positioned immediately adjacent the half section 16 of body 12 where an indicia (not shown) is present indicating the location of the manually-activated switch 30 and including the designation “on/off.” Further, it is desirable, but not required, that such on/off indicia be located on the half section 14 or 16 of the body 12 which engages the wrist of the wearer and is thus hidden from view.

The wrist band 10 of this invention operates as follows. Assuming for purposes of discussion that the “on/off” indicia is located on the half section 14 or 16 to be placed on the wrist of the wearer, the manually-activated switch 30 is depressed to place it in the “on” or closed position. The wrist band 10 is then placed around the wrist of the wearer and secured in place by attaching the fastening elements 20 and 22 together. In response to movement of the body 12 of the wrist band 10, the inertia switch 32 is movable to a closed position thus coupling the IC 34 to the battery 28 since the manually-activated switch 30 is also in the closed position. For purposes of this discussion, the inertia switch 32 and IC 34 may be collectively referred to as a “controller.” The IC 34 is operative to illuminate the LEDs 18 in a flashing or other type of lighting sequence. Once the lighting sequence has terminated, the IC 34 resets and can again be activated by movement of the inertia switch 32 to the closed position, so long as the manually-activated switch 30 remains closed. The battery 28 is disconnected from the inertia switch 32 and IC 34 by depressing the manually-activated switch 30 to move it from the closed to open position.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

I claim:

1. a wrist band, comprising:
a body having a first end and a second end;
a first fastening element mounted to said first end and a second fastening element mounted to said second end, said first and second fastening elements being releasably connected to one another to secure said body about the wrist of a wearer;
a number of light sources mounted to said body;
a battery coupled to said light sources;
a controller coupled to said battery and to said light sources;
a manually-activated switch coupled to said controller which is movable between a first position and a second position, said controller being effective to cause said light sources to illuminate in response to movement of said manually-activated switch to said first position, said light sources being prevented from illuminating with said manually-activated switch in said second position.

2. The wrist band of claim 1 in which said controller includes an integrated circuit coupled to an inertia switch.

3. The wrist band of claim 2 in which said inertia switch is effective to couple said controller to said battery, with said manually-activated switch in said first position, to cause said light sources to illuminate.

4. The wrist band of claim 3 in which said integrated circuit, when coupled to said battery, causes said light sources to illuminate in a flashing sequence.

5. A wrist band, comprising:
a body having a first end and a second end;
a first fastening element mounted to said first end and a second fastening element mounted to said second end, said first and second fastening elements being releasably connected to one another to secure said body about the wrist of a wearer;
a number of light sources mounted to said body;
a battery coupled to said light sources;
a manually-activated switch coupled to said battery which is movable between a first position and a second position;
an inertia switch coupled to said manually-activated switch, said inertia switch being movable between an open and closed position;
an integrated circuit coupled to said inertia switch and to said light sources, said integrated circuit being operative to illuminate said light sources with said manually-activated switch in said first position in response to movement of said inertia switch to said closed position.

6. The wrist band of claim 5 in which said inertia switch is movable to said closed position in response to movement of said body.

7. The wrist band of claim 5 in which said integrated circuit illuminates said light sources in a flashing sequence.
